(19) United States
(12) Patent Application Publication
(10) Pub. No.: US 2022/0292399 A1
(43) Pub. Date: Sep. 15, 2022

(54) PROCESSING OF REDUCTION AND BROADCAST OPERATIONS ON LARGE DATASETS WITH MUTLI-DIMENSIONAL HARDWARE ACCELERATORS

(71) Applicant: Google LLC, Mountain View, CA (US)

(72) Inventors: Bjarke Hammersholt Roune, Mountain View, CA (US); Sameer Kumar, Mountain View, CA (US)

(21) Appl. No.: 17/637,200

(22) PCT Filed: Sep. 4, 2020
(86) PCT No.: PCT/US2020/049398

§ 371 Date: Feb. 22, 2022

Related U.S. Application Data
(60) Provisional application No. 62/897,239, filed on Sep. 6, 2019.

(51) Int. Cl. G06N 20/00; G06K 9/62

(52) U.S. Cl. CPC G06N 20/00; G06K 9/6251; G06K 9/6256

(57) ABSTRACT

Methods, systems, and apparatus, including instructions encoded on storage media, for performing reduction of gradient vectors and similarly structured data that are generated in parallel, for example, on nodes organized in a mesh or torus topology defined by connections in at least two dimension between the nodes. The methods provide parallel computation and communication between nodes in the topology.

### CROSS-REFERENCE TO RELATED APPLICATIONS

This application claims priority to U.S. Provisional Application No. 62/897,239, filed on Sep. 6, 2019. The disclosure of the prior application is considered part of and is incorporated by reference in the disclosure of this application.

### BACKGROUND

This specification relates to training machine learning models.

Machine learning models receive input and generate output based on the received input and on values of model parameters. These models often need to be trained using received inputs which are very large datasets.

### SUMMARY

This specification describes technologies relating to parallel processing of large datasets in general, and specifically to parallel processing large datasets in various node topologies for faster reduce, map, and broadcast operations on a plurality of nodes of topology. The nodes are networked together and can be executed in hardware by a hardware accelerator. The hardware accelerator can include a plurality of networked processors operating in parallel (e.g., in a mesh array, a torus configuration, etc.). More specifically, a cross replica sum (CRS) operation is configured to sum gradient contributions from multiple replicas in data parallel stochastic gradient descent (SGD) training on such networks. For scalable performance of SGD training on the multiple replicas, at a given batch size, the gradient contributions are combined (e.g., summed). However, this process can typically be a bottleneck of performance for machine learning models (e.g., a neural network model) because reduce-scatter and gather phases of the CRS operation are conducted over a series of one dimensional (1D) loops in the network. For example, a circle algorithm, such as a rotated pincer algorithm, executes a global summing operation over a 1D configuration of the nodes of the topology. This configuration is suboptimal because it does not utilize all of the router links between the nodes of the topology. Rather, the 1D algorithm is executed in a first dimension in series with executing the 1D algorithm in a second dimension, and some of the router links are left dormant during this time.

To overcome this problem, this disclosure describes a process for executing CRS operations in multiple dimensions of the topology using multi-dimensional circle algorithms. The multi-dimensional algorithms are configured to pipeline direct memory access (DMA) transfers with summing operations to increase throughput of the CRS operation. This is achieved by executing circle algorithms in multiple dimensions simultaneously so that gradient contributions of the sum can be replicated in multiple dimensions of the topology at the same time. Because the router links between nodes of the topology are more fully utilized in comparison to a series execution of 1D algorithms in each dimension of the multidimensional topology, latencies of CRS operations can be reduced substantially, and in some cases by over 200%. Reducing the latency of CRS operations removes a major bottleneck for training machine learning models.

In one aspect, a method is described for processing training data. A respective replica of a machine learning model can be trained on each node of a plurality of nodes organized in a multi-dimensional topology including rows and columns of nodes. Each node can be trained on a respective batch of training data in parallel. After the training, each node can hold a respective gradient vector resulting from the training. The respective gradient vectors in the nodes can be combined to generate a final gradient vector by performing operations comprising: performing, by code executing on the nodes, a first phase of a circle algorithm for each of the rows of the multi-dimensional topology in parallel to generate in each node of the row different combined data for a portion of the gradient vector; performing, by code executing on the nodes, a second portion of the first phase of the circle algorithm for each of the columns of the multi-dimensional topology in parallel to generate in each node of the column a different column result comprising a portion of the combined data from each of the rows; performing, by code executing on the nodes, a first portion of a second phase of the circle algorithm for each of the columns of the multi-dimensional topology in parallel to generate in each column a portion of the final gradient vector comprising each column result; and performing, by code executing on the nodes, a second portion of the second phase of the circle algorithm for each of the rows of the multi-dimensional topology in parallel to generate in each row the final gradient vector comprising each portion of the final gradient vector from each of the columns.

In some variations, one or more of the following can be additionally implemented either individually or in any feasible combination. The method can further include: determining a type of the multi-dimensional topology of the plurality of nodes; based on the type, mapping the first portion of the first phase to a first set of nodes and a first set of links between the first set of nodes; and mapping the second portion of the first phase to a second set of nodes and a second set of links between the nodes, the first set of links being different from the second set of links.

The method can further include: determining that the multi-dimensional topology of the plurality of nodes comprises wrap-around links; and configuring each row and column of the multi-dimensional topology to execute the circle algorithm using the wrap-around links.

Each node of the multi-dimensional topology can include at least two sub-nodes. The multi-dimensional topology can include a torus topology, wherein the sub-nodes of each node are configured to be neighboring nodes of the circle algorithm for each row and for each column. The multi-dimensional topology can include a mesh topology, wherein the sub-nodes of edge nodes of the mesh are configured to be neighboring nodes of the circle algorithm for each row and for each column.

The multi-dimensional topology can include a set of nodes in a third dimension in addition to the rows and the columns, wherein the method further includes: performing, by code executing on the set of nodes in the third dimension, a third portion of the first phase of the circle algorithm in parallel to generate in each node of the column a different third dimensional result comprising a portion of the column result from each of the columns; and performing, by code executing on the set of nodes in the third dimension, a third portion of the first phase of the circle algorithm in parallel to generate the final gradient vector from each of the columns in each node of the set of the nodes in the third dimension.

The method can further include pipelining data transfer between each of the nodes with the execution of the code on each of the nodes during performing of the first phase of the circle algorithm and performing the second phase of the circle algorithm. The circle algorithm can include a rotated pincer algorithm, wherein the first phase includes a reduce-scatter phase of the rotated pincer algorithm, and the second phase includes a global gather phase of the rotated pincer algorithm. The combined data for the portion of the gradient vector includes summed data from two or more nodes of the row. The portion of the combined data from each of the rows includes summed data that includes the combined data from two or more nodes of the column.

The details of one or more embodiments of the process and system are set forth in the accompanying drawings which are given by way of illustration only, and the description below. Other features, aspects, and advantages of the invention will become apparent from the description, the drawings, and the claims. Like reference numbers and designations in the various drawings indicate like elements.

### BRIEF DESCRIPTION OF THE DRAWINGS

FIG. 1 illustrates an example system of machine learning model replicas.

FIG. 2 illustrates an example of processing units connected in a 1D torus topology on an example module showing performance of a reduce scatter phase of a circle algorithm.

FIG. 3 illustrates an example of the processing units connected in a circular topology showing performance a reduce scatter phase of a circle algorithm.

FIG. 4 is a diagram of an example multi-dimensional topology including a two-dimensional (2D) torus showing performance of the reduce scatter phase of the circle algorithm.

FIG. 5 illustrates an example of the processing units connected in the circular topology of FIG. 3 showing performance of a global gather phase of a circle algorithm.

FIG. 6 is a diagram of the multi-dimensional topology of FIG. 4 showing performance of the global gather phase of the circle algorithm.

FIG. 7 is a diagram of a multi-dimensional topology including a two-dimensional (2D) mesh topology showing performance of the reduce scatter phase of the circle algorithm.

FIG. 8 is a diagram of a multi-dimensional topology including the 2D mesh topology showing performance of the global gather phase of the circle algorithm.

FIG. 9 is a diagram of a multi-dimensional topology including a 2D torus topology including multiple processors for each node.

FIG. 10 is a diagram of a multi-dimensional topology including a 2D mesh topology including multiple processors for each node.

FIG. 11 is a flow diagram showing operations for performing CRS operations in multiple dimensions.

FIG. 12 is a flow diagram showing an example process for combining the respective gradient vectors for each node of a multi-dimensional topology.

Like reference numbers and designations in the various drawings indicate like elements.

### DETAILED DESCRIPTION

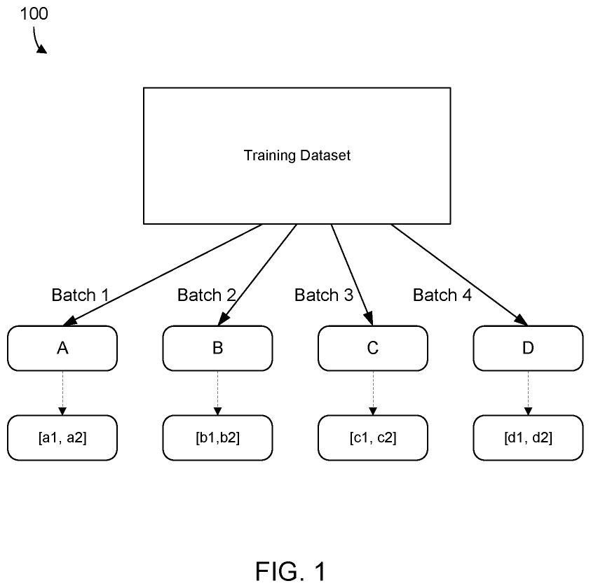

A common strategy for training a machine learning model is to process batches of training data in parallel on multiple processing units. FIG. 1 illustrates an example system 100 of machine learning model replicas A-D each being trained on a corresponding processing unit. For convenience, the replicas and the processing units on which they are found may both be referred to by the same designation in the figures.

When trained, a machine learning model is defined by values of the model parameters. The model parameters are generally organized as non-scalar data, e.g., as a vector, a two-dimensional (2D) matrix, a three-dimensional (3D) matrix, or a matrix of higher degree, whose elements are generally scalar values, e.g., integers or floating point numbers.

In the system, at each iteration of a model training process, each replica (also called nodes) of a model is trained on a unique batch of training data, e.g., from a training dataset. In FIG. 1, replicas A-D are trained on batches 1-4, respectively. When a node has finished processing its batch of training data, the node has a set of gradients for the values of the model parameters. In the example of FIG. 1, when nodes A-D have finished processing batches 1-4, respectively, nodes A, B, C, and D have gradient values [a1, a2], [b1, b2], [c1, c2], and [d1, d2], respectively. The structure of the gradient values in each node is the same and generally corresponds to the structure of the parameter values. For convenience, these are referred to as vectors.

In this disclosure, a node generally refers to a portion of the system that executes logic of the CRS operations and logic other operations. While the node does not necessarily correspond to a hardware processor, a description specifying that the node is performing a logic operation (e.g., a sum) implies that the hardware on which the node is executed is performing processing operations to execute the logic operation.

Because the replicas are trained on different data, the gradient vectors of the nodes are combined to generate a final gradient vector, which is used to update the parameter values (e.g., a parameter vector) of the model. One way to combine the gradient vectors is to generate an element-wise average. The updated parameter values are communicated to all machine learning model nodes, generally in anticipation of another iteration of processing a batch of training data and combining, (e.g., reducing), the gradient vectors of each replica to a final gradient vector (e.g., a reduced gradient vector) and updating the parameter values of the model. Portions of the gradient vector that are communicated to each node of the model can be referred to as shards of the gradient vector.

Some machine learning systems have a central parameter computation subsystem that receives the gradient vectors from each replica and combines them at a central location. This specification describes technologies that can be used in machine learning systems that do not have a central parameter computation subsystem and instead reduce gradient vectors and update parameter values in a distributed fashion in the nodes. The operations for accomplishing this are referred to as cross replica sum (CRS) operations, which generally include two phases: a global summing operation (also called a reduce scatter phase) and a global gather operation (also called a gather phase). The CRS operation replicates (e.g., gathers) the final gradient vector on all nodes of the network. In some implementations, element-wise averaging occurs during the reduce scatter phase as contributions from each node are combined.

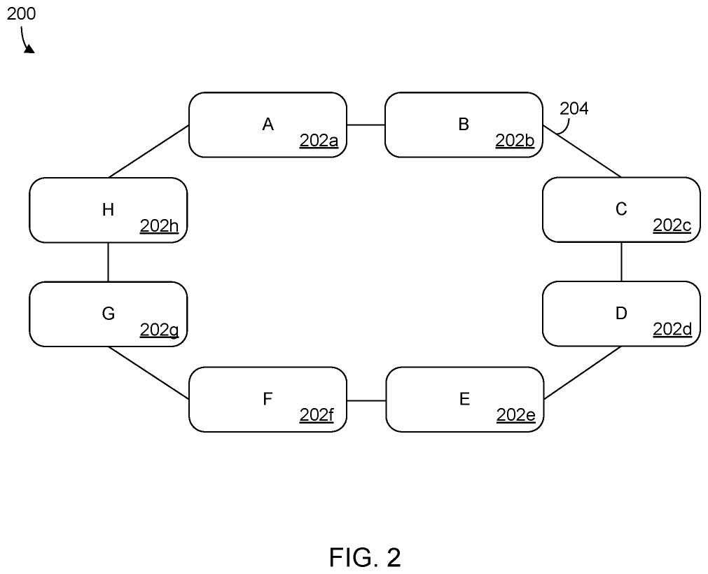

FIG. 2 illustrates a topology of high-speed connections connecting an example assemblage of processing units A-H (202a-202h) connected in a circular topology 200. In some implementations, all the processing units are on a single module. The lines shown in FIG. 2 (such as line 204) between the processing units represent high-speed data communication links. The processing units generally manufactured on multiple integrated circuits (“chips”). In some implementations, each chip can include multiple processing units (e.g., two processing units). The links that cross chip boundaries are referred to as inter-chip network links, while processing units on the same chip communicate over intra-chip interface links. The links can include half-duplex links on which only one processing unit can transmit data at a time or full-duplex links on which data can be transmitted in both directions simultaneously. Full duplex links can be represented as two arrows between nodes if the link is configured for transmitting data in both directions for a particular operation. However, for any figures referenced in this description, a link represented by a single arrow does not necessarily imply a half-duplex link, but rather represents a direction of data flow for a particular operation represented in the figure.

Methods for performing a reduction in this topology will now be described in reference to nodes (e.g., processing units) A-H 202a-h. The reduction has a summing phase, and a gather phase, which may include a broadcast phase. These are referred to as circle algorithms.

A single-path algorithm has one of the nodes, e.g., node A, send data to one neighbor, e.g., node B. B is configured to combine (e.g., add) the data from A to its own data and send the sum to C, which repeats this operation and sends to D, and so on. The processing, sending, and receiving of data can be performed in a streaming fashion. For example, B is configured to begin adding before B has received all the data from A. In this example, the final combination occurs in node H. The final gradient vector is then communicated to the other nodes A-G from H. This can be done by reversing the streaming data path from H back to A. If broadcast functionality is available to one or more nodes enabling a node to broadcast to multiple nodes, communication of the final gradient vector can be done using the broadcast functionality to complete the global gather phase of the CRS operation. The single-path circle algorithm includes N steps for each of the reduce phase and the gather phase, where N corresponds to the number of nodes.

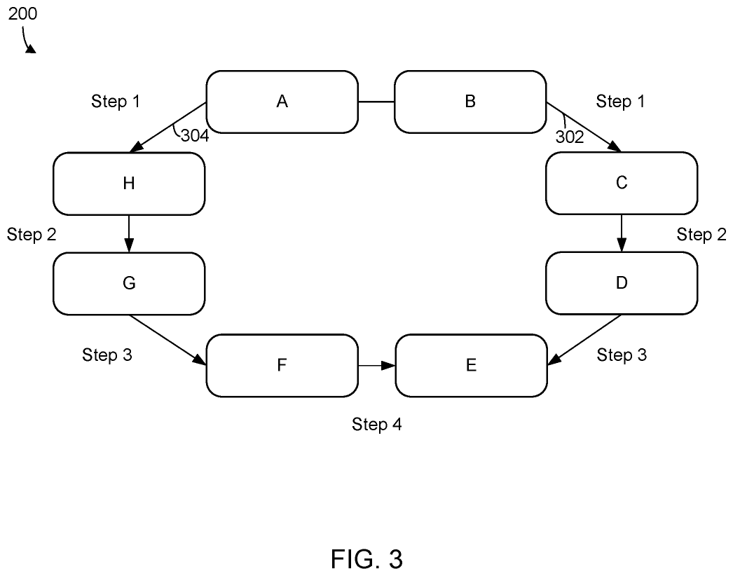

To realize lower latency than that of the single-path algorithm, a pincer algorithm sends data across two paths in opposite directions on the nodes 202a-h of the topology 200. FIG. 3 shows an example of the circle topology of FIG. 2 that is configured to perform the pincer algorithm, as shown by arrows such as arrows 302, 304, etc. In the example of FIG. 3, nodes A and B send data to nodes H and C, respectively, at approximately the same time (step 1). Nodes H and C each send the combined data to nodes G and D, respectively (step 2). Nodes G and D each send the combined data to nodes F and E, respectively (step 3). Nodes F and E include the sum across paths A-H-G-F and B-C-D-E, respectively. If the number of nodes is even, then the data has to be transferred from F to E (step 4) or vice versa and combined there before it is broadcast to all the nodes.

A rotated pincer algorithm can reduce a latency of reduce and gather phases even further. For the rotated pincer algorithm, independent instantiations of the pincer algorithm are performed simultaneously, starting from every pair of adjacent nodes. For example, while the pincer algorithm is running starting from nodes A and B, the same algorithm is running starting from nodes B and C, from C and D, etc. The gradient vector is partitioned into disjoint subsets of equal size, if possible, or essentially equal size, and each of the instantiations of the algorithm handles one of those subsets. This may change how streaming works, because now B, for example, will be sending one subset of data to C while C is sending another subset of data to D. In this example, C will not be forwarding data from B until it is done sending out its own data. To do this, the data transmitted from B to C is stored temporarily on C. Alternatively, the processing of data arriving at C from B and D may be interleaved.

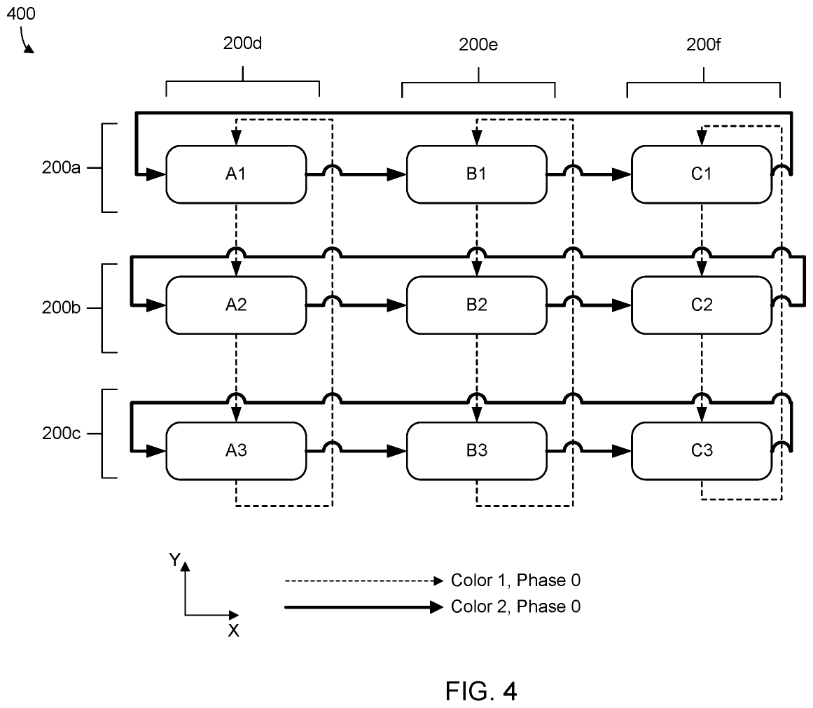

The improved rotated pincer algorithm described below reduces the latency further if the number of nodes is even. For the improved rotated pincer algorithm, node A first sends half its data to node H (as shown by arrow 304) and the other half to node B (and in turn, node C, as shown by arrow 302). The pincer algorithm subsequently continues as previously described. The data path is thus symmetric in each of the two directions from A. If a node is configured to broadcast to each other node, the node sends the data in the reverse direction. For example, node E sends the data in the reverse direction and, as the final step, nodes B and H send disjoint halves of the data to A, so that A still receives all the data shards of the gradient vector. In FIG. 4, the arrows are configured to show the reduce scatter phase of the CRS operation.

The processes can be configured using control messages. For example, a control message can configure each reduction instantiation, which subset of the gradient vector is to be handled by the process, whether it is a starting unit, final unit, or intermediate unit in the reduction, and in which direction the data or combined data and the broadcasts should be sent, as described above. The control messages are configured based on the particular topology of the nodes. As subsequently described, the control messages can be configured to take advantage of additional links that are provided in multi-dimensional topologies, such as 2D meshes and 2D torus topologies.

The process performed by each intermediate processing unit is described as follows. Each intermediate processing unit (e.g., a node) combines its gradient vector or a portion of its gradient vector with the input gradient vector it received upon receipt of a portion of an input gradient vector from a previous processing unit (e.g., an upstream processing unit). The combining operation performed by each processing unit can be a simple sum or some other computation that combines the gradient vectors. The intermediate processing unit then transmits the combined gradient vector to the next processing unit on the direction (e.g., a downstream processing unit).

A final processing unit (e.g., a node) combines its gradient vector with the input gradient vector it received upon receipt of an input gradient vector from a previous processing unit in the direction of the data path (e.g., an upstream processing unit) and generates a final reduced gradient vector. The final processing unit generally combines the reduced gradient vector with the values of the machine learning model parameters to produce an updated set of parameter values. Assuming a vector of parameters x and the gradient dx, a simple update has the form: x+=−learning_rate*dx, where the learning_rate is a scalar term. The update rules can be arbitrarily complicated, e.g., they can depend on previous gradients. After calculating the updated parameters, the final processing unit initiates a broadcast operation that provides the updated parameter values to all other processing units by reversing the flow of the data sending the final output through the processing units in the direction all the way back to the root processing unit (e.g., node). As a result, each of the nodes will have the updated parameters to use in processing the next batch of machine learning training data.

FIG. 4 is a diagram of an example multi-dimensional topology including a two-dimensional (2D) torus 400 showing performance of the reduce scatter phase of the circle algorithm. The torus topology 400 includes (in this example) nine replicas and processing nodes A1 through C3, each of which is part of two circles of three nodes, a horizontal one (labeled X) and a vertical one (labeled Y), and each of which has direct links to four other nodes. In some examples, horizontal circles of three nodes in the 2D topology 400 and vertical circles of three nodes in the 2D topology 400 correspond to rows of the 2D topology 400 and columns of the 2D topology 400, respectively. While a 3×3 topology is shown for purpose of explanation, the topology can be increased or reduced in size from topology 400. For example, a topology for processing large machine learning models, e.g., models with 10, 25, or 50 million parameter values, a suitable number of processing nodes would be larger, for example, 16 nodes in each circle and 256 nodes in all. Larger or smaller numbers would be suitable for larger or smaller models.

An iterative reduction algorithm on a torus simplifies reduction on a torus to a series of reductions on circles. The first step is to do a circle reduction along each of the rows of the 2D topology 400. First, any of the circle reduction algorithms described above is performed in each row of the 2D topology 400, resulting in the nodes in a row each having a sum vector for every gradient vector originally in the nodes of the row. Next, a circle reduction is performed along each of the columns of the 2D topology 400, at the end of which the same final gradient vector is in every node.

As disclosed previously, a reduction has a summing step, a compute step, and a broadcast step. The initial row-circle reductions should not perform a complete compute step because the gradients have not actually finished summing on the torus, even if the computation on the circle has completed.

To reduce latencies that are introduced by the iterative reduction algorithm described previously, the topology 400 can be configured to execute the rotated pincer algorithm in to multiple dimensions. For example, the reduce-scatter operations described in relation to FIG. 3 for the in rotated pincer algorithm is executed in two phases for the 2D topology 400. In the first phase, which is denoted as phase 0 in FIG. 4, a reduce scatter operation is executed along a first dimension (e.g., a horizontal dimension, or an X direction). For example, each circle, such as circle 200a including A1, B1, and C1; 200b including A2, B2, and C2; and 200c including A3, B3, and C3, executes the reduce scatter as described in relation to FIG. 3. The first reduce scatter operation is followed by a second reduce scatter operation in a second dimension (e.g., a vertical dimension, or a Y dimension). For example, each circle, such as circle 200d including A1, A2, and A3; circle 200e including B1, B2, and B3; and circle 200f including C1, C2, and C3, executes the reduce scatter operation as shown in FIG. 3 in parallel. The reduce scatter operation is conducted in two portions because topology 400 has two dimensions. Additional portions of the reduce scatter operation are performed for additional dimensions of the topology 400.

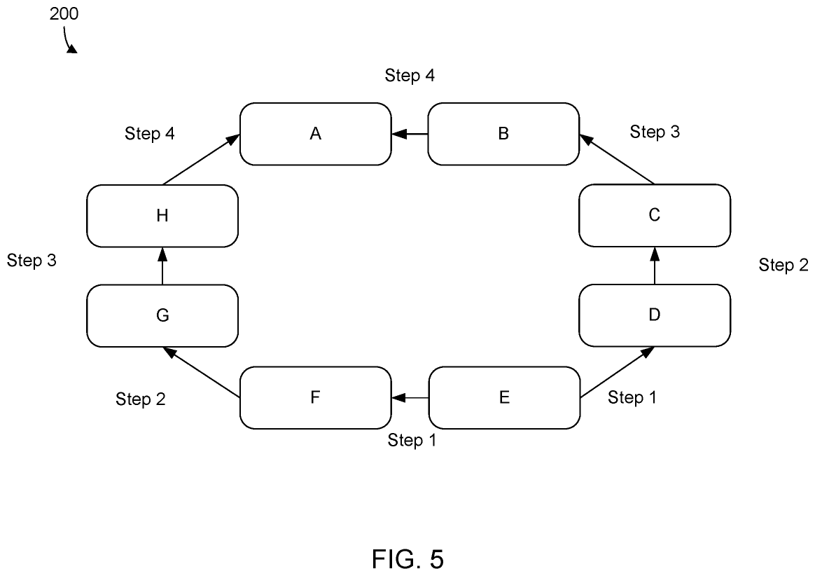

Turning to FIG. 5, an illustration is shown of an example of the processing units connected in the circular topology 200 showing performance of a global gather phase of a circle algorithm. Node E, which includes the sum from each of the nodes A-D and F-H, sends its data to nodes D and F (step 1). The nodes F and D hold this data and also send the summed data to nodes G and C, respectively (step 2). Subsequently, the nodes G and C each repeat this process, saving the total gradient vector data and sending the data to nodes H and B, respectively (step 3). H and B respectively send the data to node A (step 4). Alternatively, node E can send the summed data to node F in step 1. Nodes F and E can then simultaneously send the data to nodes G and D, respectively in step 2, and so forth, propagating the data through nodes H and C and ending at nodes A and B, respectively.

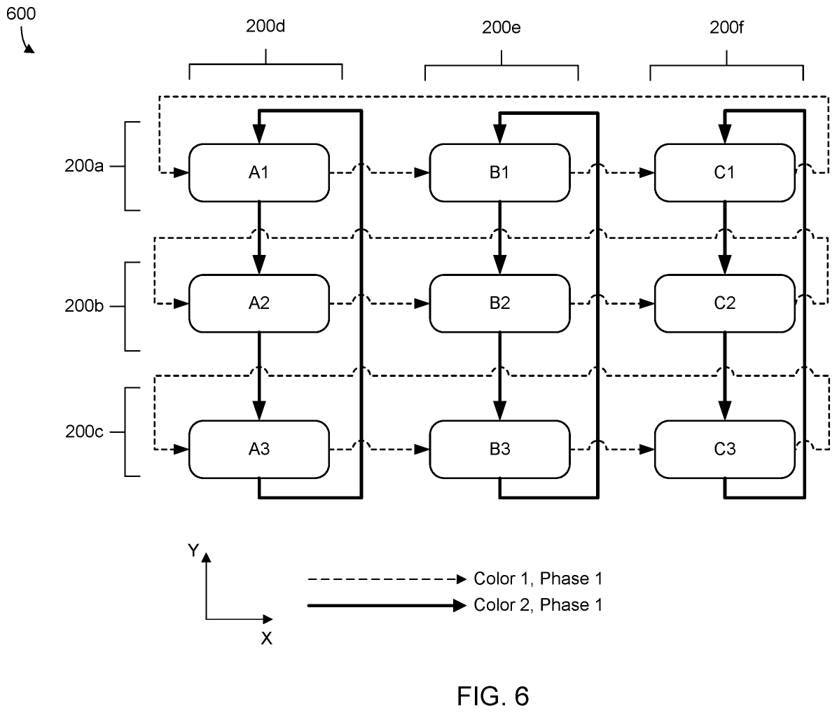

Turning to FIG. 6, a diagram is shown illustrating the multi-dimensional topology 400 of FIG. 4 showing performance of the global gather phase of the circle algorithm previously described. The reduce scatter operations described in relation to FIG. 4 for each dimension of the multi-dimensional topology are followed a global gather phase (phase 1 shown in FIG. 6) in each dimension of the network. The gather phase for the topology 400 includes two portions, one for each dimension. The two gather portions are performed in the reverse order of dimensions relative to the order described for the reduce scatter operation described in relation to FIG. 4. For example, the first gather portion occurs along the Y dimension, in loops (or circles) 200d including A1, A2, and A3; loop 200e including B1, B2, and B3; and loop 200f including C1, C2, and C3. The second portion of the gather phase is performed along the horizontal (X) dimension, including loops 200a including A1, B1, and C1; loop 200b including A2, B2, and C2; and loop 200c including A3, B3, and C3.

The data payload in the vertical (Y) dimension is the total summing payload scaled down by the size of the horizontal (X) dimension. In other words, a data shard in the X dimension is the entire reduction span in the Y dimension. The time overhead for short cross-replica-sum calls in the 2D rotated pincer algorithm is O(2*(size(X)+size(Y))). On a large 2D mesh or torus, the time overhead is smaller than O(size(X)*size(Y)) in the 1D algorithm.

The 2D circle algorithm is configured to utilize more router links of a 2D topology. Returning to FIG. 4 and FIG. 6, the 2D circle algorithm can be executed concurrently along the X and Y dimensions. Each of these two concurrent steps (each comprising executing the 2D circle along one of multiple dimensions) is called a color. A multi-color all-reduce concurrently executes in phases along the different dimensions of the multi-dimensional topology during the reduce scatter phase (phase 0, shown in FIG. 4). For the global gather phase (phase 1, shown in FIG. 6), the order of the dimensions is changed so that each node of the topology ends with the final gradient vector. For a 2D topology, as shown in FIGS. 4 and 6, the order of the X and Y dimensions is flipped from phase 0 to phase 1. For example, a two-color all-reduce can be configured to execute along the X dimension followed by the Y dimension in color 1, while it will execute the Y dimension followed by the X dimension in color 2. Such a two color scheme can be extended to n-colors on an n-dimensional mesh or torus. The multi-colors enable higher throughput as more links are simultaneously utilized during each of the reduce scatter phase and the gather phase of the CRS operation.

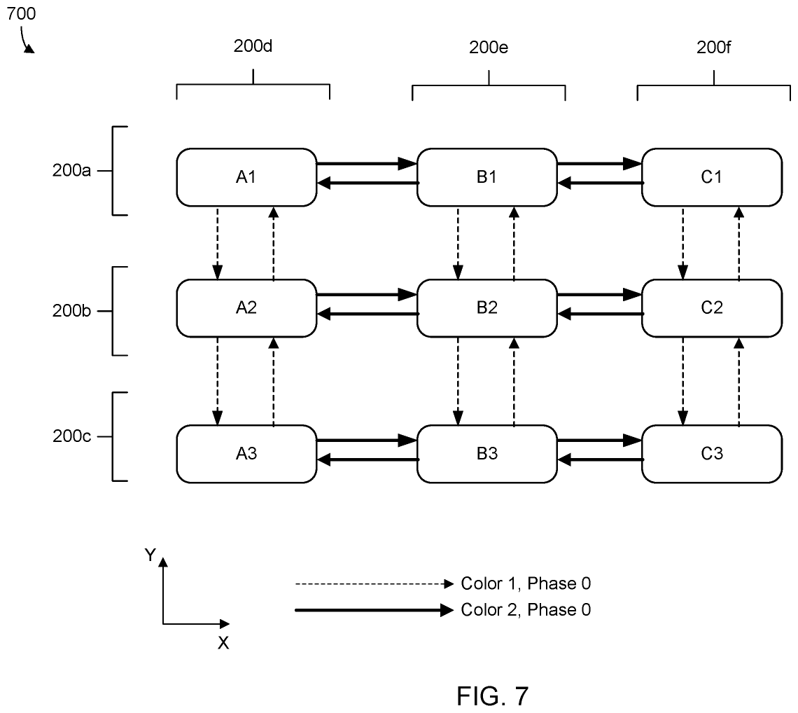

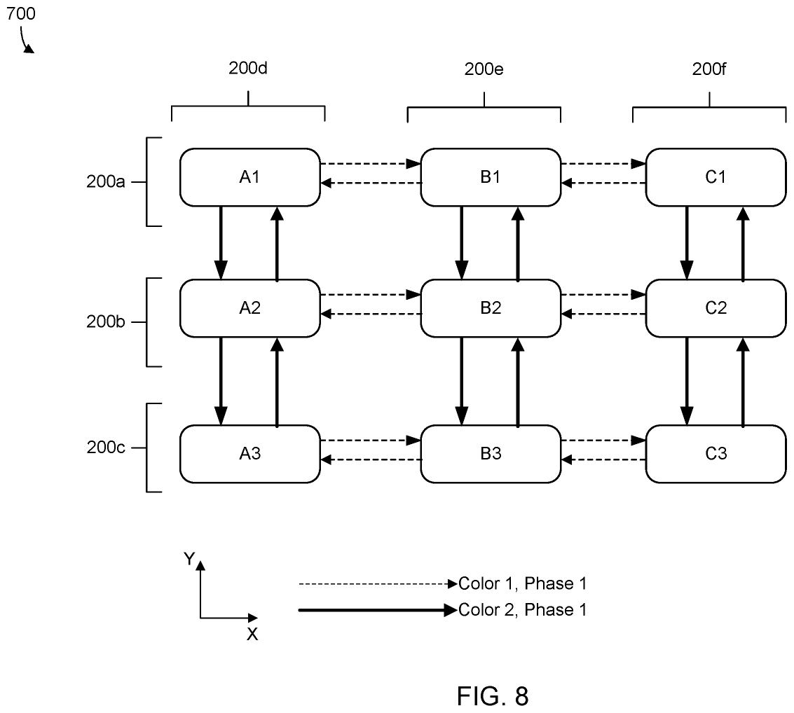

The algorithms described in this specification can be executed on other topologies. Turning to FIGS. 7-8, a 2D mesh 700 topology is shown. The mesh 700 is configured in a similar manner as the torus topology 400 for execution of each of the reduce scatter phase (phase 0 of FIG. 7) and the gather phase (phase 1 of FIG. 8). For the mesh 700, full duplex links can be utilized to create the loops 200a-200f, rather than wrap around links as in topology 400. Similar to topology 400, the multi-color all-reduce concurrently executes in phases along the different dimensions of the multi-dimensional topology during the reduce scatter phase (phase 0, shown in FIG. 7). For the global gather phase (phase 1, shown in FIG. 8), the order of the dimensions changed so that each node of the topology ends with the final gradient vector. For a 2D topology, as shown in FIGS. 7-8, the order of the X and Y dimensions is flipped from phase 0 to phase 1. For example, a two-color all-reduce can be configured to execute along the X dimension followed by the Y dimension in color 1, while it will execute the Y dimension followed by the X dimension in color 2. Such a two color scheme can be extended to n-colors on an n-dimensional mesh or torus. The multi-colors enable higher throughput as more links are simultaneously utilized during each of the reduce scatter phase and the gather phase of the CRS operation.

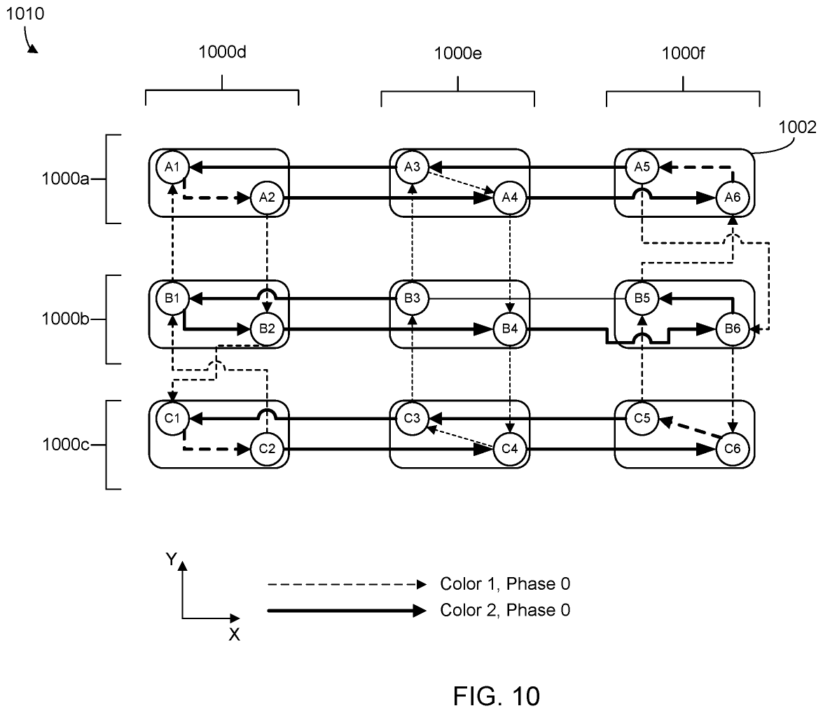

In some implementations, to create the loops 200a-f in a mesh 700, as subsequently described, each of nodes A1-C3 can include multiple cores which enables each node to use a different core to process the data received. For example, each of nodes A1-C3 can include two or more cores, each functioning in a similar manner to a node with a single core. The cores can be connected internally to the node such that loops 200a-200f are formed in the mesh 700, as described in relation to FIG. 10.

Other topologies are also possible. For example, a 16×4 topology can execute the CRS operation. This topology can include are wrap-around links in a dimension with 16 nodes but not in another dimension with 4 nodes. The algorithms would be modified to use circle reduction in the dimension with wrap-around links and some form of line reduction, e.g., the single-path algorithm described previously, in the dimension without wrap-around links. Each of the algorithms can be implemented in a distributed way by processes or threads running on the processing units.

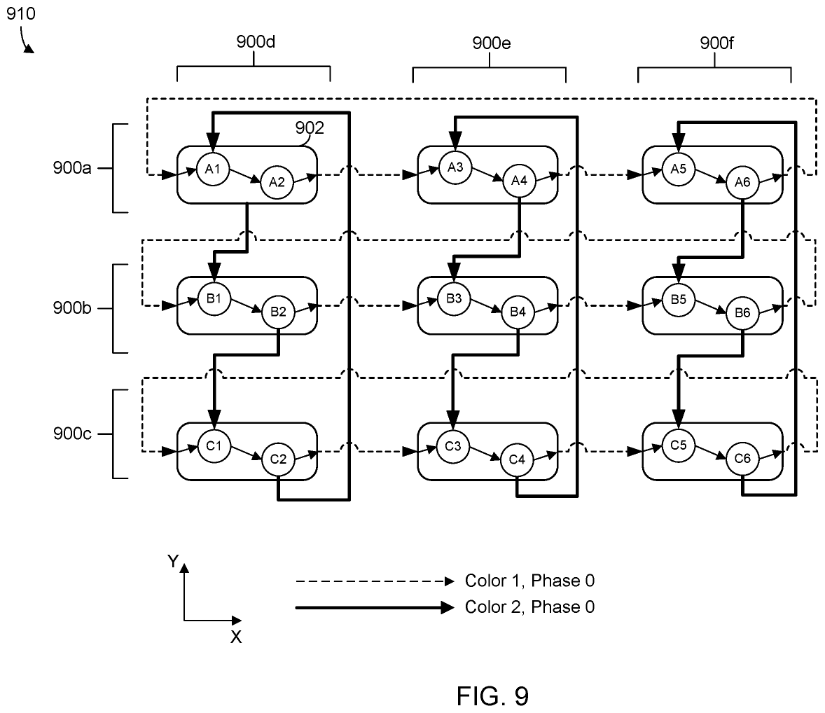

Turning to FIG. 9, a multi-dimensional topology 910 including a torus is shown in which each node includes multiple processing cores. Loops 900a-900f are formed by inter-node links and by intra-node links, and are similar to loops 200a-200f of FIGS. 4 and 6. For example, node 902 includes processing cores A1 and A2, which each function as nodes as described previously. Thus loop 900a includes six cores A1-A6, loop 900b includes six cores B1-B6, loop 900c includes cores C1-C6, loop 900d includes cores A1-A2, B1-B2, and C1-C2, loop 900e includes cores A3-A4, cores B3-B4, and nodes C3-C4, and loop 900f includes cores A5-A6, B5-B6, and C5-C6. When mapping this topology to a physical computing system, each node, such as node 902, represents a chip, and the cores, such as cores A1-A2 of node 902, represent the processing cores of the chip. While two cores are shown per chip, any number of cores that are physically on the chip can be included as cores in the loops 900a-900f.

Mapping the loops to the physical links of chips is now described. The loop neighbors of loops 900a-900f are mapped to the physical torus links. In addition, the local contributions between the processing cores on a chip (e.g., chip 902) are summed. This summing operation is pipelined with the summing operations across peer chips on the ICI network.

As previously discussed, bi-directional rings with full-duplex links are used to reduce latency of the phases (e.g., the reduce scatter phase and the gather phase) in the rotated pincer algorithm. The bi-directional loop has reduced synchronization and buffering overheads, relative to a unidirectional loop because loop neighbors do not go more than one step ahead of each other. Thus, a 1-bit adder can be used to designate an address of the target buffer on the downstream neighbor for sending the shard. In contrast, for a unidirectional ring, an explicit flow control packet must be sent by the receiver back to the sender when buffers on the receivers are available to receive packets.

On torus networks, such as that represented in topology 910, the bidirectional ring maps directly to the physical links of the torus. As shown in FIG. 9, cores of each chip can be sequentially linked to form the loops 900a-900f for both dimensions. This scheme takes advantage of torus links in a Torus network. Here, the loops 900a-900f are built along the nodes (e.g., chips) in a dimension of the torus network. Within each chip the data shards arrive at one of the cores (e.g., A1 of chip 902). Packets are summed and then sent downstream to the peer tensor core on the same chip (e.g., A2 of chip 902). In the next step, data shards (e.g., data packets) are sent from the second core on a chip node to the first core of the downstream chip. The zig-zag transfer ensures that half the communication from any tensor core is within the chip.

As one of the peers (e.g., neighbors) for any core is within the same chip, this scheme reduces the communication load on the inter-chip torus links from network packets by a factor of two as compared with a mesh scheme.

While the torus links directly map to the hardware links, for a mesh topology, some transfers on the bi-directional ring will share links with other peer's transfers. Turning to FIG. 10, a 2D mesh topology 1010 with loops 1000a-1000f is shown. In this scheme, the links of a single mesh dimension are used in both directions to build the loops 1000a-1000f. At the corners of the mesh, such as corner 1002, data shards are routed between the two cores (e.g., cores A5, A6) of the corner chip. In this approach the neighbors in the bi-directional rotated-pincer algorithm are physical neighbors on the mesh network or peers on the same chip at the corners. Thus, loop 1000a includes nodes A1, A2, B2, C1, C2, and B1; loop 1000b includes nodes A3, A4, B4, C4, C3, and B3, and so forth as shown in FIG. 10. Similar to mesh 700, the different colors 1 and color 2 can be concurrently executed on the topology 910. The links which are shared for both colors 1 and 2 are shown as bolded and dashed. An additional buffer can be used to ensure that the colors can be executed concurrently in this scheme.

The connections between cores of each chip of the topologies 910 and 1010 of FIGS. 9 and 10, respectively, are determined based on whether torus links are available. In some implementations, if torus links are available, the hardware is configured according to topology 910 because there are fewer inter-chip links needed for the torus loops 900a-f in comparison with the mesh loops 1000a-f described above. However, when torus wrap-around links are not available, the system can configure the loops using the mesh topology 1010 and still form the loops for executing the circle algorithms in each dimension.

When executing both colors concurrently on 2D meshes and tori, in practice, a first communication is executed along the rows and then along the columns for the first color, and executed along the columns first and then along the rows for the second color. This is provably optimal when there are two cores per chip and results in all network links utilized in each of the reduce scatter and gather phases. Rotated pincer algorithm performance is generally dominated by the first phase. In the second phase, a volume of data communicated is scaled down by the size of the first dimension. Thus, the second phase does not add significant overhead to the multi-dimensional rotated pincer algorithm as the payload transferred on the network is significantly smaller than the first phase.

To achieve high utilization on the torus links (e.g., highly parallel DMA transfers), a single descriptor can be injected along all four directions to the clockwise and counterclockwise neighbors in each of the two colors. This can be done for each shard step of the rotated pincer algorithm. Spreading descriptors in this fashion prevents head-of-line blocking in which descriptors along a direction can block descriptors along other directions. The number of injection cycles is determined by the shard payload size which depends on the cross replica sum size and size of the torus dimensions.

Floating point summing operations for the cross replica sum can be executed by vector operations with payload in vector memory. To have the payload in vector memory (VMEM), it must be transferred from high-bandwidth memory (HBM) to VMEM by DMA operations. The summed output is sent downstream in the loop. The size of the shard in VMEM can determine the throughput achieved on the torus links. If the size of the shard is small the performance of the transfer will be dominated by the latency of the torus links. Each transfer (clock-wise or counter clock-wise) in a color can require five buffers of size shard-size that are used concurrently at any instant while the cross replica sum executes on the chip cores. These shard-sized buffers are used to transfer data from HBM to VMEM and to receive the shard from the upstream replica. A 1-bit counter can be used to synchronize sender and receive. The shard-sized buffers can be used to sum network the contribution with the corresponding local contribution in VMEM. The shard-sized buffers can be used to transfer the summed result to a downstream replica (e.g., a node).

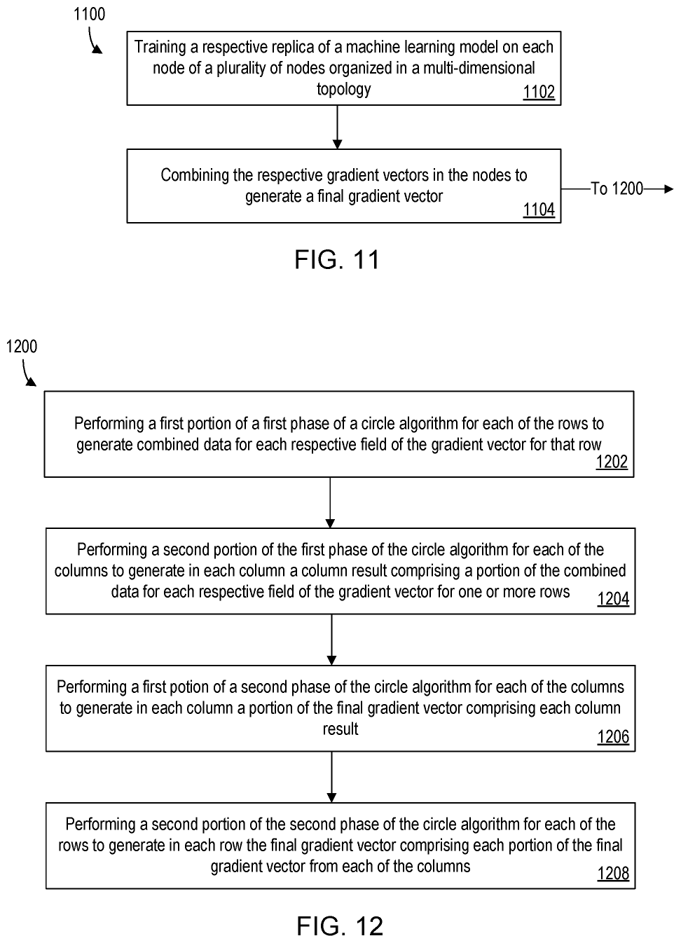

FIGS. 11-12 are flow diagrams showing operations for performing CRS operations in multiple dimensions. In FIG. 11, process 1100 includes training (1102) a respective replica of a machine learning model on each node of a plurality of nodes organized in a multi-dimensional topology comprising rows and columns of nodes. Each node is trained on a respective batch of training data in parallel. After the training, each node holds a respective gradient vector resulting from the training. Process 1100 includes combining (1104) the respective gradient vectors in the nodes to generate a final gradient vector. Combining the respective gradient vectors is described in process 1200 of FIG. 12.

FIG. 12 is a flow diagram showing an example process 1200 for combining the respective gradient vectors for each node of a multi-dimensional topology. Process 1200 includes performing (1202), by code executing on the nodes, a first portion of a first phase of a circle algorithm for each of the rows of the multi-dimensional topology in parallel to generate in each row combined data for each respective field of the gradient vector for that row. Process 1200 includes performing (1204), by code executing on the nodes, a second portion of the first phase of the circle algorithm for each of the columns of the multi-dimensional topology in parallel to generate in each column a column result comprising a portion of the combined data for each respective field of the gradient vector for one or more rows. In some implementations, the first and second portions, which can be referred to as colors, can be performed concurrently with one another to fully utilize DMA transfers for the multi-dimensional topology. In some implementations, the first phase is referred to as a reduce scatter phase.

The process 1200 includes performing (1206), by code executing on the nodes, a first potion of a second phase of the circle algorithm for each of the columns of the multi-dimensional topology in parallel to generate in each column a portion of the final gradient vector comprising each column result. The process 1200 includes performing (1208), by code executing on the nodes, a second portion of the second phase of the circle algorithm for each of the rows of the multi-dimensional topology in parallel to generate in each row the final gradient vector comprising each portion of the final gradient vector from each of the columns. In some implementations, the first and second portions of the second phase can be executed concurrently to fully utilize the DMA transfers of the multi-dimensional topology. The second phase can be referred to as a gather phase.

For each of processes 1100 and 1200, each node of the multi-dimensional topology can include at least two sub-nodes (or even more sub-nodes). The process 1200 can further include pipelining data transfer between each of the nodes with the execution of the code on each of the nodes during performing of the first phase of the circle algorithm and performing the second phase of the circle algorithm, so that sum and transfer operations are performed concurrently for one or more of the nodes.

In some implementations, the circle algorithm includes a rotated pincer algorithm as described previously. The multi-dimensional topology can include a torus topology or a mesh topology, as described previously. For torus topologies, the sub-nodes of each node (which can represent a chip in a torus network) can be sequentially linked in the node. In some implementations, where the multi-dimensional topology comprises a mesh topology, and where each node of the mesh comprises at least two sub-nodes, each of the nodes can be linked by a bi-directional link (e.g., a full duplex link).

The processes 1100, 1200 can include mapping the topology of nodes to a physical computing architecture by determining a type of the multi-dimensional topology of the plurality of nodes, and, based on the type, mapping the first portion of the first phase to a first set of nodes and a first set of links between the first set of nodes. In addition, the process includes mapping the second portion of the first phase to a second set of nodes and a second set of links between the nodes, the first set of links being different from the second set of links.

In some implementations, the multi-dimensional topology includes a set of nodes in a third dimension in addition to the rows and the columns, to form a three dimensional topology. Here, the first phase of the circle algorithm includes a corresponding third portion for execution by the set of nodes of the third dimension (e.g., a third color can be added). Additionally, the second phase of the circle algorithm includes a corresponding third portion for execution by the set of nodes of the third dimension (to complete execution of the third color).

In some implementations, the combined data for each respective field of the gradient vector for each row comprises summed data for each respective field of the gradient vector for that row. The combined data for each respective field of the gradient vector for each column comprises summed data for each respective field of the gradient vector for that column.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. In this specification, the terms “vector,” “vector data,” and “vector elements” are used broadly to refer to any non-scalar data. In addition to vectors examples of non-scalar data are strings, arrays, structs, matrices, and tensors.

The reduce and update functions described in this specification are merely examples and entirely independent of the invention itself. Additionally, the invention is described as being used for machine learning, but can be used for any purpose that involves reducing data that is distributed across a network.

Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1-12. (canceled)

13. A method for processing training data using processing hardware, the method comprising:
training a respective replica of a machine learning model on each node of a plurality of nodes organized in a multi-dimensional topology comprising rows and columns of nodes, wherein each node is trained on a respective batch of training data in parallel, whereby after the training each node holds a respective gradient vector resulting from the training; and
combining the respective gradient vectors in the nodes to generate a final gradient vector by performing operations comprising:
performing, by code executing on the nodes, a first phase of a circle algorithm for each of the rows of the multi-dimensional topology in parallel to generate in each node of the row different combined data for a portion of the final gradient vector;
performing, by code executing on the nodes, a second portion of the first phase of the circle algorithm for each of the columns of the multi-dimensional topology in parallel to generate in each node of the column a different column result comprising a portion of the combined data from each of the rows;
performing, by code executing on the nodes, a first portion of a second phase of the circle algorithm for each of the columns of the multi-dimensional topology in parallel to generate in each column a portion of the final gradient vector comprising each column result; and
performing, by code executing on the nodes, a second portion of the second phase of the circle algorithm for each of the rows of the multi-dimensional topology in parallel to generate in each row the final gradient vector comprising each portion of the final gradient vector from each of the columns.

14. The method of claim 13, further comprising:
determining a type of the multi-dimensional topology of the plurality of nodes;
based on the type, mapping the first portion of the first phase to a first set of nodes and a first set of links between the first set of nodes; and
mapping the second portion of the first phase to a second set of nodes and a second set of links between the nodes, the first set of links being different from the second set of links.

15. The method of claim 13, further comprising:
determining that the multi-dimensional topology of the plurality of nodes comprises wrap-around links; and
configuring each row and column of the multi-dimensional topology to execute the circle algorithm using the wrap-around links.

16. The method of claim 13, wherein each node of the multi-dimensional topology comprises at least two sub-nodes.

17. The method of claim 16, wherein the multi-dimensional topology comprises a torus topology, and wherein the sub-nodes of each node are configured to be neighboring nodes of the circle algorithm for each row and for each column.

18. The method of claim 16, wherein the multi-dimensional topology comprises a mesh topology, and wherein the sub-nodes of edge nodes of the mesh are configured to be neighboring nodes of the circle algorithm for each row and for each column.

19. The method of claim 13, wherein the multi-dimensional topology includes a set of nodes in a third dimension in addition to the rows and the columns, wherein the method further comprises:
performing, by code executing on the set of nodes in the third dimension, a third portion of the first phase of the circle algorithm in parallel to generate in each node of the column a different third dimensional result comprising a portion of the column result from each of the columns; and
performing, by code executing on the set of nodes in the third dimension, a third portion of the first phase of the circle algorithm in parallel to generate the final gradient vector from each of the columns in each node of the set of the nodes in the third dimension.

20. The method of claim 13, further comprising pipelining data transfer between each of the nodes with the execution of the code on each of the nodes during performing of the first phase of the circle algorithm and performing the second phase of the circle algorithm.

21. The method of claim 13, wherein the circle algorithm comprises a rotated pincer algorithm, wherein the first phase comprises a reduce-scatter phase of the rotated pincer algorithm, and wherein the second phase comprises a global gather phase of the rotated pincer algorithm.

22. The method of claim 13, wherein the combined data for the portion of the final gradient vector comprises summed data from two or more nodes of the row, and wherein the portion of the combined data from each of the rows comprises summed data comprises the combined data from two or more nodes of the column.

23. A data processing apparatus comprising a plurality of processing units, each processing unit corresponding to a respective node, wherein the data processing apparatus is configured to perform operations, the operations comprising:
training a respective replica of a machine learning model on each node of a plurality of nodes organized in a multi-dimensional topology comprising rows and columns of nodes, wherein each node is trained on a respective batch of training data in parallel, whereby after the training each node holds a respective gradient vector resulting from the training; and
combining the respective gradient vectors in the nodes to generate a final gradient vector by performing operations comprising:
performing, by code executing on the nodes, a first phase of a circle algorithm for each of the rows of the multi-dimensional topology in parallel to generate in each node of the row different combined data for a portion of the final gradient vector;
performing, by code executing on the nodes, a second portion of the first phase of the circle algorithm for each of the columns of the multi-dimensional topology in parallel to generate in each node of the column a different column result comprising a portion of the combined data from each of the rows;
performing, by code executing on the nodes, a first portion of a second phase of the circle algorithm for each of the columns of the multi-dimensional topology in parallel to generate in each column a portion of the final gradient vector comprising each column result; and
performing, by code executing on the nodes, a second portion of the second phase of the circle algorithm for each of the rows of the multi-dimensional topology in parallel to generate in each row the final gradient vector comprising each portion of the final gradient vector from each of the columns.

24. The data processing apparatus of claim 23, wherein the operations further comprise:
determining a type of the multi-dimensional topology of the plurality of nodes;
based on the type, mapping the first portion of the first phase to a first set of nodes and a first set of links between the first set of nodes; and
mapping the second portion of the first phase to a second set of nodes and a second set of links between the nodes, the first set of links being different from the second set of links.

25. The data processing apparatus of claim 23, wherein the operations further comprise:
determining that the multi-dimensional topology of the plurality of nodes comprises wrap-around links; and
configuring each row and column of the multi-dimensional topology to execute the circle algorithm using the wrap-around links.

26. The data processing apparatus of claim 23, wherein the multi-dimensional topology includes a set of nodes in a third dimension in addition to the rows and the columns, wherein the operations further comprise:
performing, by code executing on the set of nodes in the third dimension, a third portion of the first phase of the circle algorithm in parallel to generate in each node of the column a different third dimensional result comprising a portion of the column result from each of the columns; and
performing, by code executing on the set of nodes in the third dimension, a third portion of the first phase of the circle algorithm in parallel to generate the final gradient vector from each of the columns in each node of the set of the nodes in the third dimension.

27. The data processing apparatus of claim 23, wherein the operations further comprise pipelining data transfer between each of the nodes with the execution of the code on each of the nodes during performing of the first phase of the circle algorithm and performing the second phase of the circle algorithm.

28. One or more non-transitory computer-readable storage media encoded with instructions which when executed by processing hardware cause the processing hardware to perform operations, wherein the operations comprise:
training a respective replica of a machine learning model on each node of a plurality of nodes organized in a multi-dimensional topology comprising rows and columns of nodes, wherein each node is trained on a respective batch of training data in parallel, whereby after the training each node holds a respective gradient vector resulting from the training; and
combining the respective gradient vectors in the nodes to generate a final gradient vector by performing operations comprising:
performing, by code executing on the nodes, a first phase of a circle algorithm for each of the rows of the multi-dimensional topology in parallel to generate in each node of the row different combined data for a portion of the final gradient vector;
performing, by code executing on the nodes, a second portion of the first phase of the circle algorithm for each of the columns of the multi-dimensional topology in parallel to generate in each node of the column a different column result comprising a portion of the combined data from each of the rows;
performing, by code executing on the nodes, a first portion of a second phase of the circle algorithm for each of the columns of the multi-dimensional topology in parallel to generate in each column a portion of the final gradient vector comprising each column result; and
performing, by code executing on the nodes, a second portion of the second phase of the circle algorithm for each of the rows of the multi-dimensional topology in parallel to generate in each row the final gradient vector comprising each portion of the final gradient vector from each of the columns.

29. The computer-readable storage media of claim 28, wherein the operations further comprise:
determining a type of the multi-dimensional topology of the plurality of nodes;
based on the type, mapping the first portion of the first phase to a first set of nodes and a first set of links between the first set of nodes; and
mapping the second portion of the first phase to a second set of nodes and a second set of links between the nodes, the first set of links being different from the second set of links.

30. The computer-readable storage media of claim 28, wherein the operations further comprise:
determining that the multi-dimensional topology of the plurality of nodes comprises wrap-around links; and
configuring each row and column of the multi-dimensional topology to execute the circle algorithm using the wrap-around links.

31. The computer-readable storage media of claim 28, wherein the multi-dimensional topology includes a set of nodes in a third dimension in addition to the rows and the columns, wherein the operations further comprise:
performing, by code executing on the set of nodes in the third dimension, a third portion of the first phase of the circle algorithm in parallel to generate in each node of the column a different third dimensional result comprising a portion of the column result from each of the columns; and
performing, by code executing on the set of nodes in the third dimension, a third portion of the first phase of the circle algorithm in parallel to generate the final gradient vector from each of the columns in each node of the set of the nodes in the third dimension.

32. The computer-readable storage media of claim 28, wherein the operations further comprise pipelining data transfer between each of the nodes with the execution of the code on each of the nodes during performing of the first phase of the circle algorithm and performing the second phase of the circle algorithm.
